(19) United States
(12) Patent Application Publication
(10) Pub. No.: US 2013/0004327 A1
(43) Pub. Date: Jan. 3, 2013

(54) ALUMINUM FAN BLADE ROOT

(75) Inventors: Thomas J. Watson, South Windsor, CT (US); Stephen E. Pasakarnis, South Windsor, CT (US); Bradford A. Cowles, Tolland, CT (US); Blair A. Smith, South Windsor, CT (US)

(73) Assignee: UNITED TECHNOLOGIES CORPORATION, Hartford, CT (US)

(21) Appl. No.: 13/173,784

(22) Filed: Jun. 30, 2011

(51) Int. Cl. F01D 5/14; B23P 15/02

(52) U.S. Cl. 416/241 R; 29/889.7

(57) ABSTRACT

A method of improving fatigue strength in a fan blade includes fabricating a metal fan blade with an airfoil and a root and deep peening the root.

### BACKGROUND

Titanium alloys and fiber composites are the benchmark classes of materials for fan and compressor blades in commercial airline engines. One reason for the materials being so broadly adopted is that regulations require an engine in commercial service to be capable of ingesting birds while allowing for continued operation or safe and orderly shutdown of that engine. Another reason is that blade must resist cracking from nicks and dents caused by small debris such as sand and rain. Engines with titanium fan blades as well as certain reinforced fiber composite fan blades with adhesively bonded metallic leading edge sheaths are the most common blades used to meet these criteria.

While titanium blades are relatively strong, they are heavy and expensive to manufacture. Composite blades offer sufficient strength and a significant weight savings over titanium, but they are expensive to process. Further, due to their relatively low strain tolerance, composite blades require a greater thickness than otherwise equivalent metal blades to meet bird strike requirements. Greater blade thickness reduces fan efficiency and offsets a significant portion of weight savings from using composite materials.

Blades made of aluminum can result in significant weight savings. However, aluminum blades are softer and lower in strength than past titanium or composite blades. Additionally, aluminum based materials suffer from high susceptibility to various forms of corrosion, including exfoliation corrosion, intergranular corrosion, stress corrosion cracking, and galvanic corrosion, which usually evidences itself by pitting. Pits act like stress-risers that lead to premature failure of aluminum components.

### SUMMARY

A method of improving fatigue strength in a fan blade includes fabricating a metal fan blade with an airfoil and a root and deep peening the root.

An aluminum fan blade having an airfoil with a leading edge and a trailing edge and a root includes a first pressure face and a second pressure face each angled outward from horizontal; a lower horizontal face connecting the pressure faces at the bottom of the root; and a first runout fillet and a second runout fillet connecting the first and the second pressure faces, respectively, to the airfoil, wherein at least a portion of the root has undergone a deep peening process.

### BRIEF DESCRIPTION OF THE DRAWINGS

FIG. 1 is a cross-sectional view of a gas turbine engine.

FIG. 2 is a perspective view of an aluminum blade inserted in a disc.

FIG. 3 is an enlarged perspective view of a root portion of the aluminum blade of FIG. 2.

FIG. 4 is an enlarged cross-sectional view the root of the aluminum blade of FIG. 3.

FIG. 5 is a block diagram of a process for improving fatigue strength in an aluminum fan blade according to the current invention.

### DETAILED DESCRIPTION

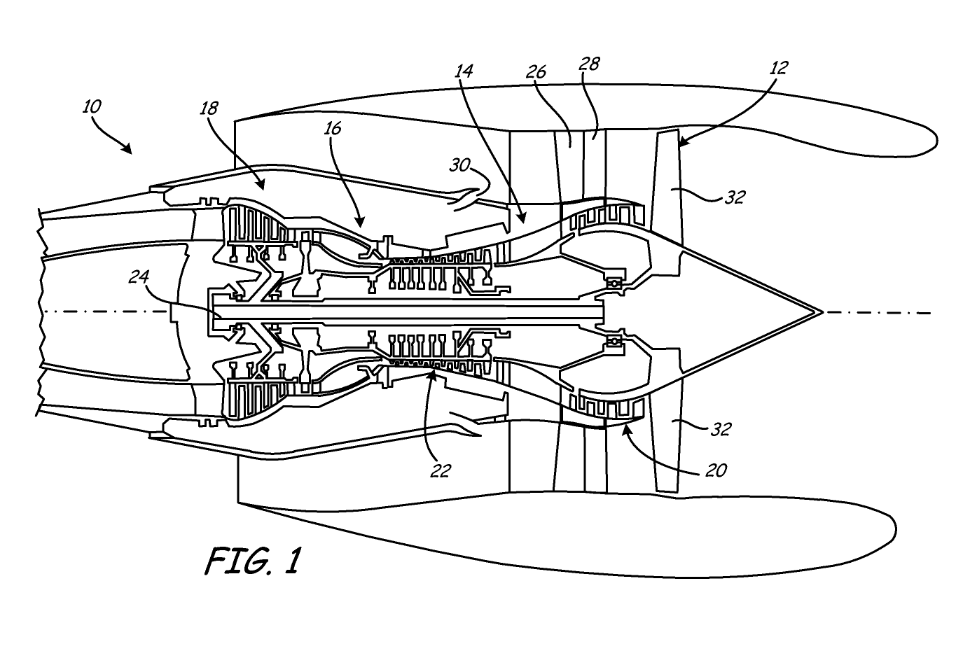

FIG. 1 is a cross-sectional view of gas turbine engine 10, which includes turbofan 12, compressor section 14, combustion section 16 and turbine section 18. Compressor section 14 includes low-pressure compressor 20 and high-pressure compressor 22. Air is taken in through fan 12 as fan 12 spins. A portion of the inlet air is directed to compressor section 14 where it is compressed by a series of rotating blades and vanes. The compressed air is mixed with fuel, and then ignited in combustor section 16. The combustion exhaust is directed to turbine section 18. Blades and vanes in turbine section 18 extract kinetic energy from the exhaust to turn shaft 24 and provide power output for engine 10.

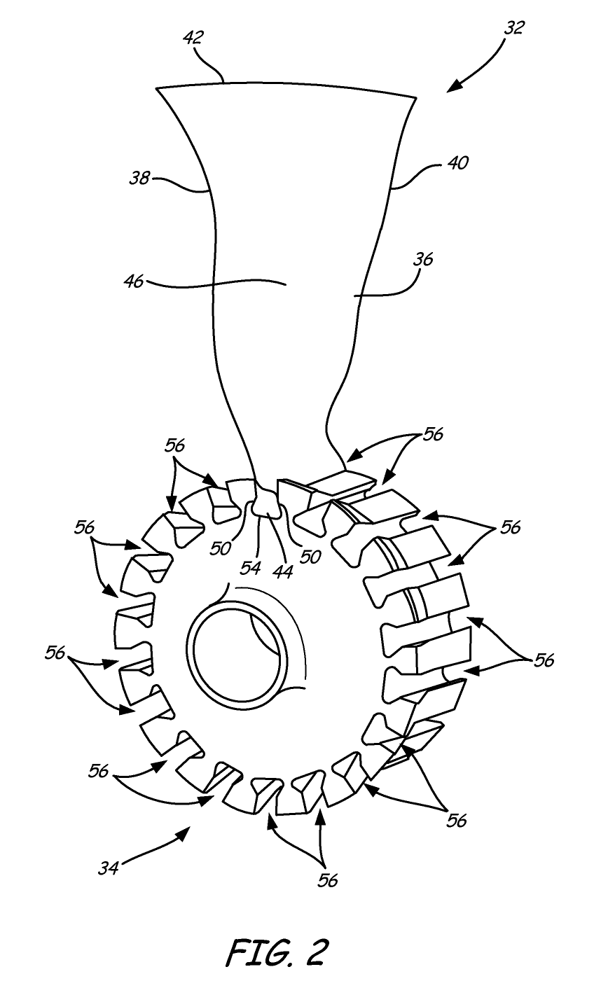

The portion of inlet air that is taken in through fan 12 and not directed through compressor section 14 is bypass air. Bypass air is directed through bypass duct 26 by guide vanes 28. Then the bypass air flows through opening 30 to cool combustor section 16, high pressure compressor 22 and turbine section 18. Fan 12 includes a plurality of aluminum blades 32 inserted into disc 34 (see FIG. 2).

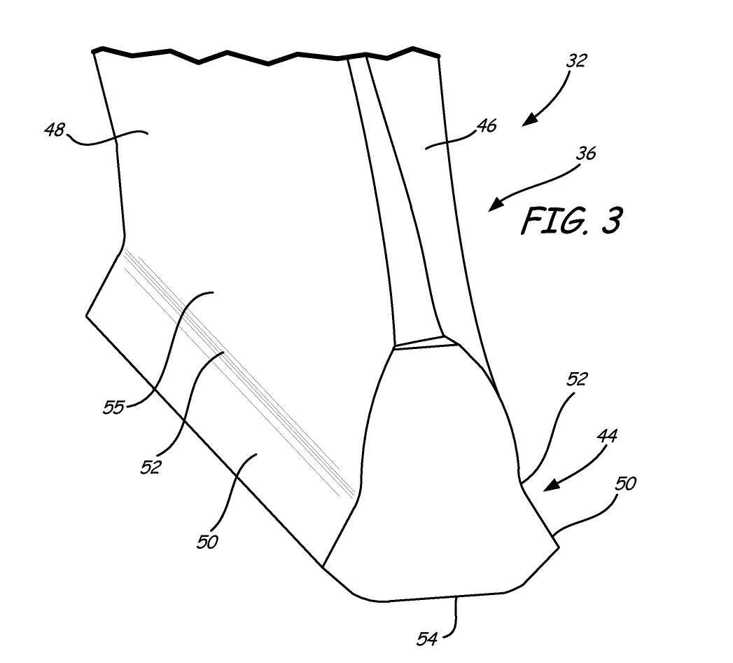

FIG. 2 illustrates one aluminum blade 32 inserted in disc 34. Blade 32 includes aluminum airfoil 36, leading edge 38, trailing edge, 40, tip 42, root 44, suction side 46 and pressure side 48 (shown in FIG. 3). Root 44 includes angled pressure faces 50, runout fillets 52, and lower horizontal face 54. Disc 34 includes slots 56. Root 44 is opposite tip 42, and is inserted in slot 56 in disc 34. While only one blade is illustrated, it is to be understood that in operation, a blade would be inserted into each slot 56 in disc 34.

Root 44 of aluminum blade 32 and slot 56 in disc 34 are shaped so that root 44 slides into slot 56 (i.e., the shapes are complementary). When fan 12 is in operation, disc 34 spins, rotating blade 32 to provide air intake for engine 10 (see FIG. 1). Blade 32 is retained in disc 34 by root 44, and specifically by angled pressure faces 50 of root 44. Pressure faces 50 angle outward from airfoil 36 at specific angles to resist centrifugal forces and hold blade 32 in disc 34 during operation.

FIG. 3 illustrates an enlarged perspective view of root 44 of aluminum blade 32 with suction side 46 and pressure side 48. Root 44 includes pressure faces 50, runout fillets 52, and lower horizontal face 54. Pressure faces 50, runout fillets 52 and lower horizontal face 54 extend in the chordwise direction of blade 32 from leading edge 38 to trailing edge 40.

Pressure faces 50 are connected to airfoil 36 suction side 46 and pressure side 48 by runout fillet 52 and to each other by lower horizontal face 54 (not shown). Root 44 can be formed by molding or by partial molding and partial machining. For example, after molding the general shape of root 44, it can be machined to further refine the shape. Deep peening can be done on pressure faces 50 and runout fillets 52.

In operation of engine, blade 32 is spun by disc 34. High inter-laminar tension stresses are produced in root 44 and specifically in fillets 52 during operation of the engine and in a severe bending load, such as an impact loading by a bird or another blade striking the airfoil. These stresses are resisted by pressure faces 50, which hold blade in disc 34 during operation and have a maximum bearing stress. The maximum bearing stress of pressure faces 50 is related to the total surface area of each pressure face 50, the characteristics of materials which make blade 32 and the finishes on faces 50.

As mentioned above, aluminum is softer, lower in strength and more highly susceptible to corrosion than titanium used in prior art metal blades. Defenses against corrosion for aluminum can include anodization, primers, paints, and many other barrier-type defenses. However, if these are breached, protection can be given to aluminum blade 32 itself through a peening process. The peening process can significantly enhance durability and damage tolerance of aluminum blade 32 by introducing compressive residual stress fields of sufficient magnitude and depth to retard or prevent development and growth of corrosion damage or fatigue crack development and propagation. Due to the thickness of root 44, a deep peening process can significantly enhance durability and damage tolerance in this critical area of blade 32 without deforming or warping root 44.

The introduction of compressive residual stresses to aluminum can be accomplished in other ways, such as Low Plasticity Burnishing (“LPB”), Laser Shock Processing (“LSP”), Ultrasonic Peening (“USP”) or conventional shot peening. These alternative methods have various drawbacks, including development and recurring costs, residual stress profiles and depth capability, surface finish after treatment and geometry limitations. LSP can attain relatively deep compression, but is expensive to develop and apply. LSP also comes with some risk of generating internal spallation damage in the article being treated. LPB is difficult to apply to regions with small features, such as the edges of root 44. LPB is also costly to develop and apply. The development and application costs of USP are lower, but it cannot provide the residual stress depth that deep peening can achieve. Conventional shot peening usually is done at an intensity of about 8 N to about 16 N and results in a compressive stress field of about 0.005 inches (0.127 mm) to about 0.010 inches (0.254 mm) below the surface. Crack propagation from small or shallow surface particles or defects is retarded approximately equal to the depth of compression.

Deep peening can produce stresses by repeated surface impingement by gas propelled shot. The shot used is considerably larger and heavier than conventional shot peening, resulting in the imparting of greater energy on the surface being peened. Deep peening can achieve an intensity range of between about 6 C and about 10 C on the Almen scale when applied to aluminum. This can result in a compressive stress field of about 0.030 inches (0.762 mm) to about 0.040 inches (1.016 mm) below the surface of root 44. Past uses of peening on aluminum blades has generally been limited to conventional shot peening due to the risks of warping created by residual stresses on the airfoil. However, deep peening can be applied to and very beneficial to root 44 due to the thickness of root 44 making it not as prone to dimensional distortion. The depth of deep peening can impede crack propagation from much larger cracks and pits, allowing, in some cases, finding of these pitting and cracks prior to detrimental propagation through visual inspection.

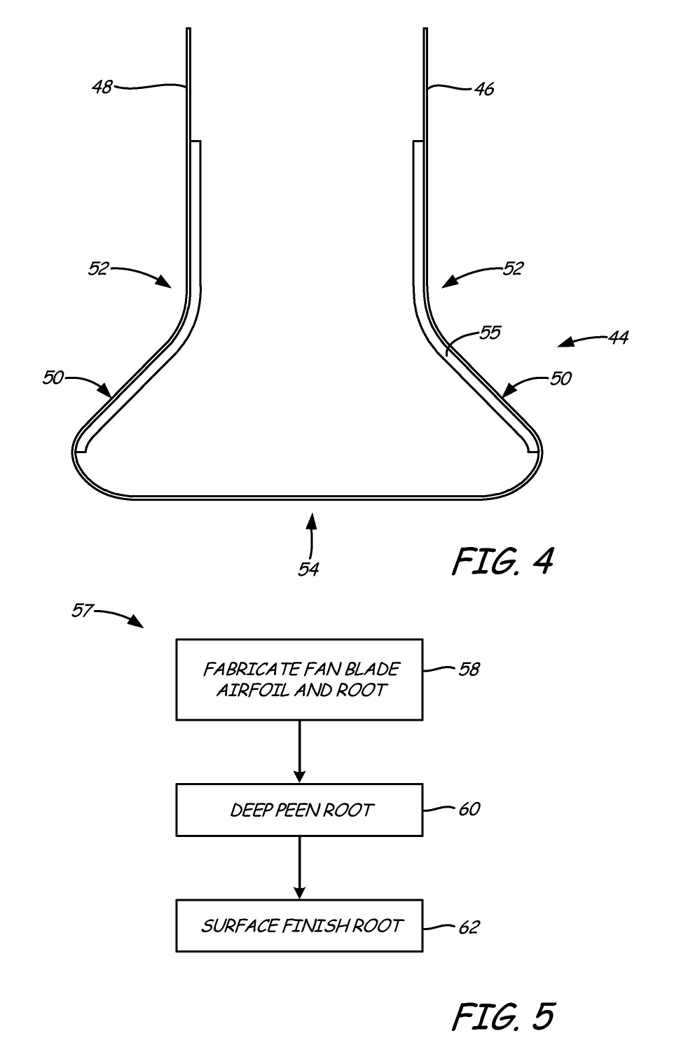

FIG. 4 illustrates cross-section of root 44 of aluminum blade 32 with suction side 46 and pressure side 48. Root 44 includes pressure faces 50, runout fillets 52, lower horizontal face 54 and areas which have been deep peened 55. Pressure faces 50, runout fillets 52 and lower horizontal face 54 extend in the chordwise direction of blade 32 from leading edge 38 to trailing edge 40.

Pressure faces 50 and runout fillets 52 of root 44 have been deep peened 55 to impart residual stresses to strengthen those areas of root 44. The deep peening 55 can be limited to only these areas through a process of shielding areas of the blade 32 that are not to be deep peened or through using deep peening equipment that is able to very accurately target only the areas desired. Shielding can be done by using a housing, a blast chamber, masking or any other means generally known in the art.

FIG. 5 is a block diagram of a process for improving fatigue strength in an aluminum fan blade according to the current invention. Process 57 includes the steps of fabricating fan blade airfoil and root of an aluminum (step 58), deep peening the root (step 60) and post-processing root (step 62).

Fabricating fan blade airfoil and root (step 58) can be done using any method known in the art, including forging, casting, rolling or machining. Airfoil 36 can be hollow or solid depending on relevant design requirements such as engine size and relative material and processing costs. Hollow airfoils can be formed by any method, such as by diffusion bonding two metal plates around their perimeters. Additionally airfoil 36 can include a sheath for added leading edge protection. Fan blade can be made of aluminum or another metal.

Deep peening blade root (step 60) can be done using gas propelled steel balls to impinge pressure faces 50 and runout fillets 52 of root 44. The balls can have a diameter of about 0.055 inches (1.397 mm) to about 0.09 inches (2.286 mm). The balls used for deep peening can be about 13 times heavier than shot generally used for conventional peening. The peening intensity can be about 6 C to about 10 C on the Almen scale, and can result in a compressive stress field reaching about 0.030 inches (0.762 mm) to about 0.040 inches (1.016 mm) below the surfaces of root 44. The process of peening can be done using an automated cabinet system where an air pressure hose gun assembly propels the steel balls into the surface of root 44. The deep peening process; size, weight and material of balls used; peening intensity and compressive stress field generated are shown for example purposes only and can be varied according to blade 32 material properties and requirements.

Post-processing root (step 62) can involve finishing peened surfaces of blade 32 root 44. This can be done by grinding root 44 using cool liquid, such as water or machining fluid. The use of cool fluid helps to maintain the compressive stress field that deep peening imposed, as heat lessens the stress and therefore the fatigue strength imposed by peening. Smoothing the surfaces of root 44 additionally improves the fatigue life and lowers pit growth rate.

Process 57 of fabricating aluminum alloy blade 32 by using a deep peening process on root 44 significantly enhances the durability and damage tolerance of root 44. The introduction of compressive residual stress fields to root 44 through aggressive deep peening helps to prevent and retard corrosion damage and crack propagation in root 44. Deep peening is also more cost-effective and practical than other methods of imposing residual stress fields. Additionally, it is a practical method for imposing compressive stress on root 44, as deep peening is able to be applied continuously around root 44.

While the invention has been discussed in relation to aluminum fan blades, it could be applicable to other types of metal fan blades, such as titanium blades. While the discussion of blade materials has been in relation to aluminum and titanium, this is meant to include aluminum alloys and titanium alloys as well. While the deep peening process has been discussed in relation to using gas propelled shot, the process of imparting deep residual stresses on the root can be done in other ways and using other techniques.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of improving fatigue strength in a fan blade, the method comprising:
fabricating a metal fan blade with an airfoil and a root; and
deep peening the root.

2. The method of claim 1, wherein the fan blade is substantially made of aluminum.

3. The method of claim 1, wherein the step of deep peening of the root comprises:
imparting compressive residual stress fields on the root through gas propelled shot.

4. The method of claim 1, wherein the step of deep peening of the root comprises:
deep peening with an intensity of about 6 C to about 10 C.

5. The method of claim 1, wherein the deep peening results in a compressive stress field which reaches about 0.030 inches (0.762 mm) to about 0.040 inches (1.016 mm) below the root surface.

6. The method of claim 1, wherein the root comprises:
a first pressure face and a second pressure face each angled outward from horizontal;
a lower horizontal face connecting the pressure faces at the bottom of the root; and
a first runout fillet and a second runout fillet connecting the first and the second pressure faces, respectively, to the airfoil.

7. The method of claim 6, wherein the deep peening is performed on the first pressure face, the second pressure face and the first and second runout fillets.

8. The method of claim 1, and further comprising:
finishing the surfaces peened.

9. The method of claim 8, wherein the step of finishing the surfaces peened comprises:
grinding the root to smooth out the surfaces peened.

10. The method of claim 9, wherein the grinding is done with cool water.

11. The method of claim 9, wherein the grinding is done with cool machining fluid.

12. An aluminum fan blade having an airfoil with a leading edge, a trailing edge and a root, wherein the root comprises:
a first pressure face and a second pressure face each angled outward from horizontal;
a lower horizontal face connecting the pressure faces at the bottom of the root; and
a first runout fillet and a second runout fillet connecting the first and the second pressure faces, respectively, to the airfoil, wherein at least a portion of the root has undergone a deep peening process.

13. The blade of claim 12, wherein the root has undergone a deep peening process on the first and second pressure faces and on the first and second runout fillets.

14. The blade of claim 12, wherein the deep peening is performed with an intensity of about 6 C to about 10 C.

15. The blade of claim 12, wherein the parts peened have been surface finished.

16. The blade of claim 12, wherein the surface finish was done through grinding with a cool liquid.

17. A fan blade made of aluminum alloy, the blade comprising:
an airfoil with a leading edge and a trailing edge in a chordwise direction, a root and a tip in a spanwise direction; and
a root, comprising:
a first pressure face and a second pressure face each angled outward from horizontal and running from the leading edge to the trailing edge in the chordwise direction and each having been deep peened;
a lower horizontal face connecting the pressure faces at the bottom of the root; and
a first and a second runout fillet connecting the first and second pressure faces, respectively, to the airfoil and each having been deep peened.

18. The blade of claim 17, wherein the deep peening was performed with gas propelled shot with an intensity of about 6 C to about 10 C.

19. The blade of claim 17, wherein the deep peening results in a compressive surface stress field of about 0.030 inches (0.762 mm) to about 0.040 inches (1.016 mm).

20. The blade of claim 17, wherein the surfaces peened have undergone surface finishing.
